(19) United States
(12) Patent Application Publication
(10) Pub. No.: US 2002/0083092 A1
(43) Pub. Date: Jun. 27, 2002

(54) Method and system for automated electronic document distribution

(76) Inventor: William E. Simpson, Lake Oswego, OR (US)

Correspondence Address: WHITEFORD, TAYLOR & PRESTON, LLP, ATTN: GREGORY M STONE, SEVEN SAINT PAUL STREET, BALTIMORE, MD, 21202-1626, US

(21) Appl. No.: 10/032,045

(22) Filed: Dec. 21, 2001

Related U.S. Application Data
(60) Provisional application No. 60/257,462, filed on Dec. 22, 2000.

(51) Int. Cl. G06F 15/00

(52) U.S. Cl. 707/506; 705/1

(57) ABSTRACT

A method and system for automating a business's management of business information is provided that forms a network between an electronic document reception, storage, and distribution device and businesses across a geographically disperse area so as to enable the transfer of business information between them. Business information users may view and download prefabricated customized and noncustomized business documents, and may also upload their own business information which may be used in the creation of new customized business documents.

### CROSS-REFERENCE TO RELATED APPLICATIONS

The present application is based upon and gains priority from U.S. Provisional Patent Application Serial No. 60/257,462, filed Dec. 22, 2000 by the inventor herein and entitled “Method And System For Automated Electronic Document Distribution.”

### BACKGROUND OF THE INVENTION

1. Field of the Invention

The present invention relates generally to methods and systems for handling electronic documents, and more particularly to a method and system enabling the automated creation and distribution of both standardized and customized electronic forms, business papers, and other documents through a remote electronic document reception, storage, and distribution device. 2. Description of the Background

Management of business and legal forms can be a trying task in conducting business. All businesses, irrespective of their size, are faced with the need for business forms varying in complexity, at least from time to time. For example, retail establishments may have typical needs for sales receipt forms, payroll forms, invoicing forms, purchase order forms, and the like on a daily basis, and an occasional need for more specialized forms, such as leases, purchase contracts, supply contracts, employment agreements, and the like. Traditionally, simple business forms were obtained by travelling to a local office supply store, contracting with a custom form printer, or purchasing software to develop and print forms on an as-needed basis in house, while more specialized forms were obtained by hiring experts in the particular area of interest, such as an employment attorney for providing a form employment agreement. Whether the need is for a simple business form or for a complex legal agreement, obtaining such documents often provides the user with unwanted inconvenience and expense.

In addition to the complexity of managing a company's procurement and handling of business forms and agreements, businesses often times must also manage their internal business information in order to create, publish, distribute, and present such information to outside parties, such as advertising targets, customers, venture capitalists, investors, and the like. The presentation of such information may, for example, take the form of a business plan, annual shareholder report, or private placement memorandum, all of which represent a considerable and large-scale undertaking. Large companies in their pre-IPO efforts may publish and distribute thousands of such documents, all of which can easily approach the size of a novel. Moreover, in addition to the legal fees that businesses incur in creating such documents, their printing and distribution costs can become overbearingly expensive.

Further, even where a company is able to absorb the costs of producing such lengthy and complex documents, their limited utility for the intended reader can often result in their disposal prior to being completely reviewed by that intended reader. For example, a potential venture capitalist reviewing a number of business plans may wish to obtain a narrow piece of information, such as projected first year tax liability, but have no way of quickly extracting such a narrow piece of information from a potentially extremely lengthy document, much less from a number of documents under review at one time. Such difficulty in extracting key information can cause some potential readers to disregard the document before it has had its intended review and effect. Simultaneously, it is often necessary to include relatively detailed information in conveying a complete story, such as when presenting a business plan, that would make excessive “streamlining” of such documents unwise. Even further, some intended recipients of such documents may have a desire to store such documents over an extended term, but the storage requirements dictated by their volume often times render this option unattainable.

It would therefore be highly advantageous to provide a system and method that could enable businesses having a business information management need to more easily obtain documents needed on a repetitive basis, such as business forms and legal agreements, and to more easily disseminate business information to outside parties in a form that is more easily handled and processed by such outside parties.

### SUMMARY OF THE INVENTION

It is, therefore, an object of the present invention to provide a method and system for automating a business's management of business information that avoids the disadvantages of the prior art.

It is another object of the instant invention to provide a method and system for automating the distribution of electronic documents to and from a business based on the specific needs of such business.

It is yet another object of the instant invention to provide a method and system enabling a business to remotely access a collection of customized and non-customized forms, and to retrieve forms from such collection on an as-needed basis.

It is even yet another object of the instant invention to provide a system and method for providing a library of customized forms that are editable by a remote form author and downloadable by a remote form user.

It is still even yet another object of the instant invention to provide a method and system for creating business documents based upon information provided by remote business information providers.

In accordance with the above objects, a method and system for automating a business's management of business information is provided that forms a network between an electronic document reception, storage, and distribution device and businesses across a geographically disperse area so as to enable the transfer of business information between them. With respect to a first aspect of the invention, a remote server is provided having a storage device storing a variety of business forms, legal documents, and the like which may be viewed, downloaded, and printed by remotely situated business information users across a wide area network such as the Internet, a local area network, or any other communication network. The business forms, legal documents, and other materials accessible by business information users are preferably segmented into two collections, namely, a first collection comprising standardized forms, and a second collection comprising customized forms. In a preferred embodiment of the invention, the first collection comprises generic, non-customized business and legal forms, while the second collection comprises customized business and legal forms, for example, agreements that have been particularly configured in accordance with the laws of varying states. In this case, business information users may access the first collection without charge, while a purchase transaction is automatically initiated by the server when the business information users attempt to access the second collection. All of the business and legal forms are preferably stored on the storage device as “Portable Document Format” (“PDF”) files viewable with an appropriate PDF reader software program, such that once a user has established access to the desired form, the form may be viewed and printed, but may not be edited by the user. Customized form providers are provided secure editing access to documents that only such provider has previously transferred to the storage device, thus enabling such customized form providers to edit their own customized forms or upload additional customized forms to the second collection. Each customized form is preferably identifiable as having been generated by a particular customized form provider, such that some portion of the funds received during the purchase transaction may be divided between the entity hosting the service and the appropriate customized form provider. In another aspect of the invention, the server is also in communication with a business document production tool, such that the server may receive business information from any number of business information users and transfer such information to the business document production tool so that such information may be integrated into an electronic business document stored on a portable electronic information storage device, such as a CD-ROM.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a schematic view of a system for automating a business's management of business information according to one embodiment of the instant invention.

FIG. 2 is a schematic view of a computer server for use with the system of FIG. 1.

FIGS. 3 through 6 comprise a flow chart representing the process employed by a remote server in processing requests from business information users.

FIG. 7 comprises a flow chart representing the process employed by a remote server in processing requests from customized document providers.

### DETAILED DESCRIPTION OF THE PREFERRED EMBODIMENTS

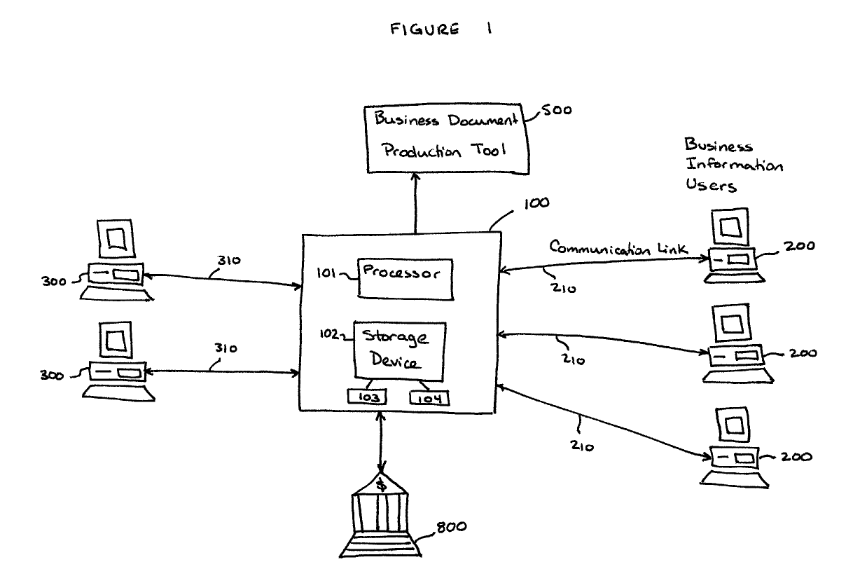

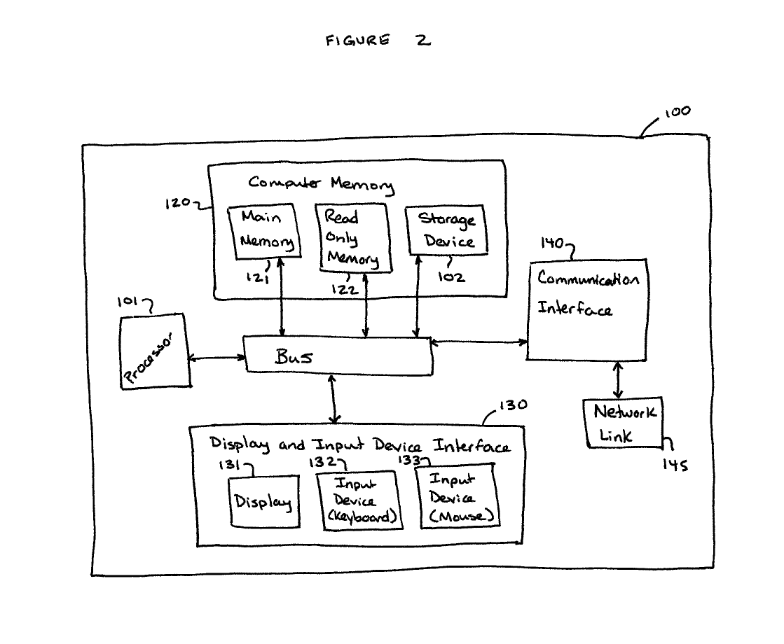

As shown in the schematic view of FIG. 1, the system of the instant invention comprises a remote computer server 100 having a processor 101, a storage device 102 for storing a plurality of computer files 103 and 104, each of which files comprises electronic documents stored as Portable Document Format (“PDF”) files viewable with an appropriate PDF reader software program, and communications hardware and software (not shown) enabling communication between server 100 and remotely situated business information users 200, customized form providers 300, external financial institutions 800, and a business document production tool 500. The PDF format of computer files 103 and 104 enables users to download, view, and readily print forms, without allowing a user to edit the forms themselves. Thus, the PDF file format provides ready, remote access to a large supply and wide variety of documents in electronic form, while preventing those who would download the forms from making modifications.

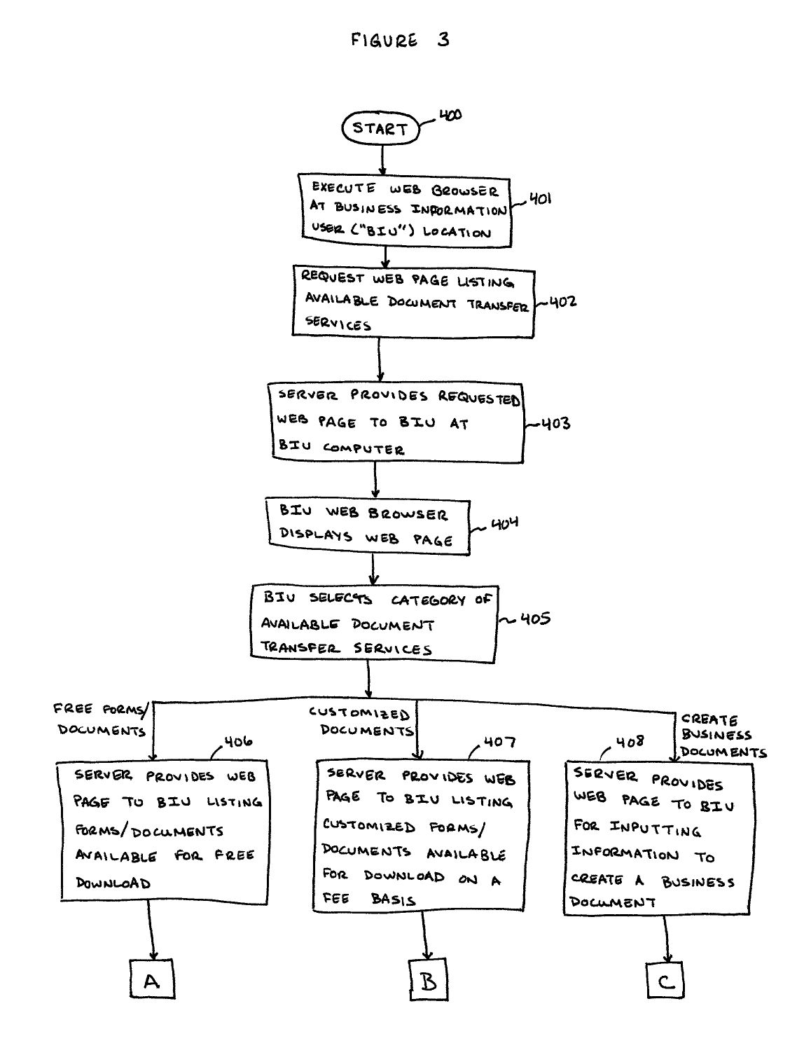

As shown more particularly in the schematic view of FIG. 2, remote server 100 comprises a bus 110 or other internal communications mechanism enabling communication between elements of server 100, and processor 101 coupled with bus 110 for processing information. Server 100 includes computer memory 120 including main memory 121, read only memory (“ROM”) 122, and storage device 102. Main memory 121 may comprise random access memory (“RAM”) or any other similarly configured dynamic storage device, and is coupled to bus 110 for storing information and instructions that are to be executed by processor 101, as well as temporary variables or other intermediate information during execution of instructions to be executed by processor 101. ROM 122 is likewise coupled to bus 110 for storing static information and instructions for processor 101. Finally, storage device 102, in the form of a magnetic disk, optical disk, or similarly configured electronic information storage device, is coupled to bus 110 for storing information and instructions.

Bus 110 also provides communication with a display and input device interface 130, which interface preferably comprises a connection mechanism for a display device 131, such as a cathode ray tube or similarly configured visual display device, a connection mechanism for a first input device such as a keyboard 132, and a connection mechanism for a second input device such as computer mouse 133, which input devices communicate information and command selections to processor 101.

Bus 110 also provides communication with a communication interface 140 which provides two-way data communication coupling to a network link 145, which link in turn provides connection to other data devices, such as to a host computer or data equipment operated by an Internet Service Provider (“ISP”), which ISP in turn provides data communication services to an external network such as the Internet. Communication interface 140 may comprise, by way of example, an integrated services digital network (“ISDN”) card, a modem, a local area network (“LAN”) card, or a wireless communication interface.

The display of forms to business information users 200, as well as the reception of new forms and receipt of editing instructions from customized form providers 300, is accomplished by server 100 in response to processor 101 executing sequences of instructions contained in main memory 121, which instructions may be read into main memory 121 from another computer-readable medium, such as storage device 102. However, the computer-readable storage medium is not limited to devices such as storage device 102, and may in fact include a floppy disk, hard disk, magnetic tape, or any other magnetic medium, a CD-ROM, DVD, or any other optical medium, punch cards, paper tape, or any other physical medium, RAM, PROM, EPROM, FLASH-EPROM, or any other memory chip or cartridge, a carrier wave embodied in an electrical, electromagnetic, infrared, or optical signal, or any other medium from which a computer may read. The display of selected forms and editing of existing forms is accomplished through execution of the sequences of instructions contained in main memory 121 which in turn cause processor 101 to perform the specified steps. In an alternate embodiment of the invention, hard-wired circuitry may be used in place of or in combination with software instructions to implement the invention. Thus, embodiments of the invention are not limited to any specific combination of hardware circuitry and software.

Business information users 200 comprise a plurality of remote, independent users each equipped with a personal computer employing a user interface such as a web browser software program. The personal computers of business information users 200 are coupled through a network 210 (such as the wide area network of the Internet) to server 100, thus allowing access to electronic business forms and legal documents stored on storage device 102, as set forth in greater detail below. Typical business information users may include individuals, small companies, large companies, venture capital firms, and the like desiring to view, download, and print customized and non-customized forms and documents.

Similarly, customized form providers 300 comprise a plurality of remote, independent users each equipped with a personal computer employing a user interface such as a web browser software program enabling remote connection to and communication with server 100. Such communication is provided through a network 310, such as the wide area network of the Internet or a Virtual Private Network (“VPN”). Typical customized form providers 300 may include law firms, title companies, mortgage companies, and the like.

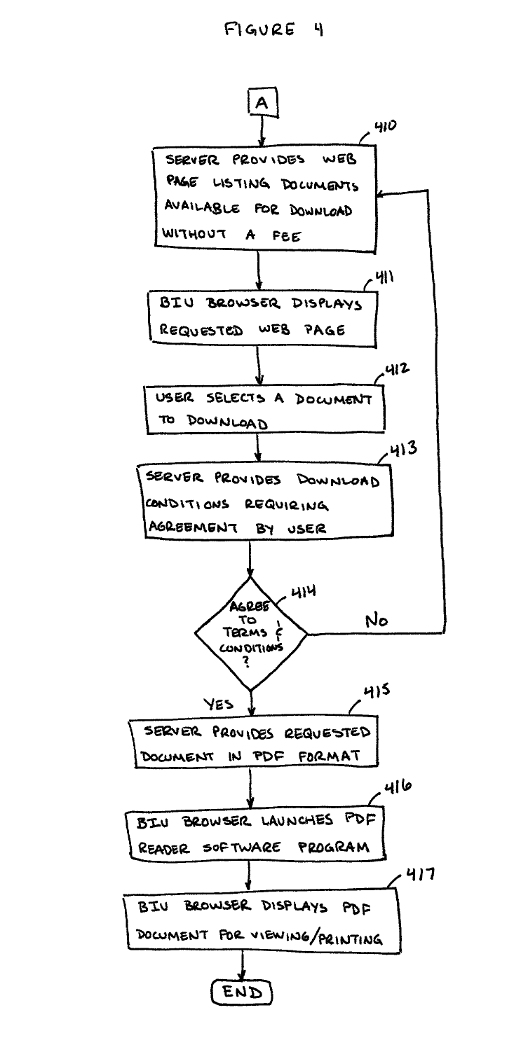

FIG. 3 is a schematic view of the process employed by server 100 to provide business information users 200 access to electronic documents stored on storage device 102. The process begins at step 400, and proceeds to step 401 where a business information user executes a web browser application on their personal computer and connects to communication link 210 enabling communication with remote hosts, such as remote server 100. Next, at step 402, the user requests a web page from remote server 100 listing available document transfer services by inputting the universal resource locater (URL) address of such web page on remote server 100. Next, at step 403, remote server 100 transmits the requested web page to the web browser on the business information user's computer 200, and at step 404, the requested web page is displayed by the business information user's web browser.

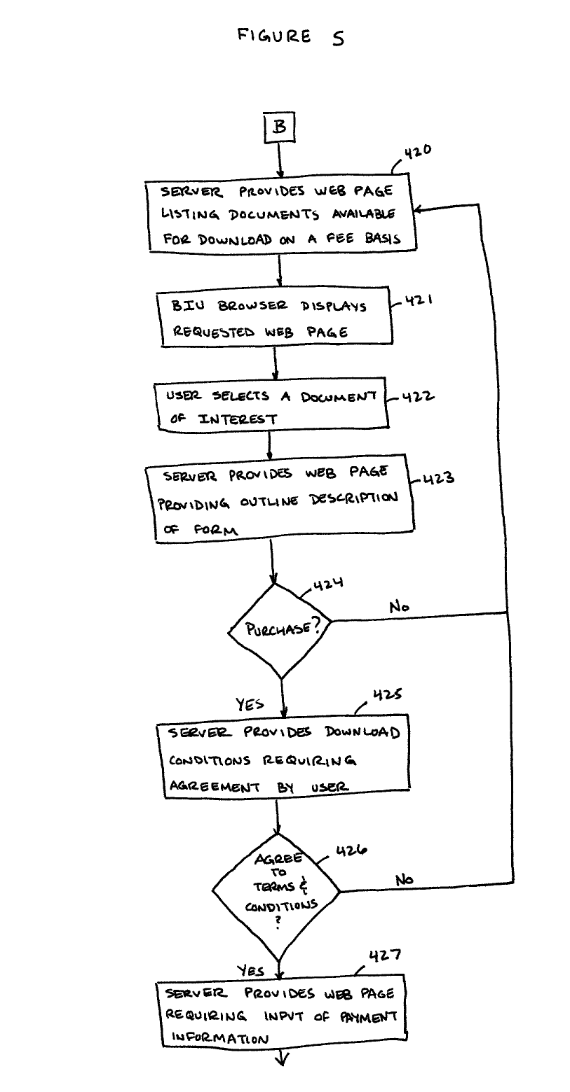

The web page preferably offers the business information user a number of selections of electronic document transfer services that are available, including for example “Free Documents,” “Customized Documents,” and “Create Business Documents.” While this division of services is considered part of a preferred embodiment of the invention, it should particularly be noted that such basic division may take many forms without departing from the spirit and scope of the instant invention. For example, “Free Documents” may be offered as “Free Forms,” “Free Contracts,” or any number of other categories having varying identifiers, while all of such forms may together be generally categorized as “Free Documents.” Likewise, “Create Business Documents” may include “Create Business Plan,” “Create Shareholder Report,” and the like, with each such subdivision falling within the general category of “Create Business Document.” At step 405, the business information user selects the particular category of document transfer services it wishes to use, such as by selecting one of the categories using a pointing device, such as a computer mouse, which selection in turn instructs the server to provide the appropriate web page associated with the selected service. Thus, in response to the business information user's selection, server 100 provides to the user either: (i) at step 406, a web page listing forms and documents available for download at no cost; (ii) at step 407, a web page listing customized documents available for download on a fee basis; or (iii) at step 408, a web page enabling user input of business information that is to be used to create a business document. FIG. 4 depicts the process undertaken when at step 406, a business information user is provided a web page listing forms and documents available for download at no cost. At step 410, server 100 provides a web page listing documents that are available for download, review, and printing without payment of a fee. At step 411, the business information user's browser displays the requested web page at the user's location, enabling a user to at step 412 select the particular document the user wishes to view. At step 413, in response to receiving the user's selection at step 412, server 100 provides a web page listing “Download Conditions”, advising the user that the documents being provided are sample documents whose use are subject to specific terms and conditions, and requiring the user to agree to such conditions before being provided access to the requested document. At step 414, the business information user may indicate that they do not agree to the “Download Conditions,” in which case they may optionally be directed back to step 410, or may indicate that they do agree to such conditions, in which case at step 415 the server provides the requested document in PDF format. At step 416, the business information user's browser then launches a PDF Reader software program, such as the PDF Reader program available from Adobe Systems Incorporated as ADOBE ACROBAT READER which is readily commercially available. Lastly, at step 417, the browser on the business information user's computer 200 displays the PDF document, enabling viewing and printing by the user.

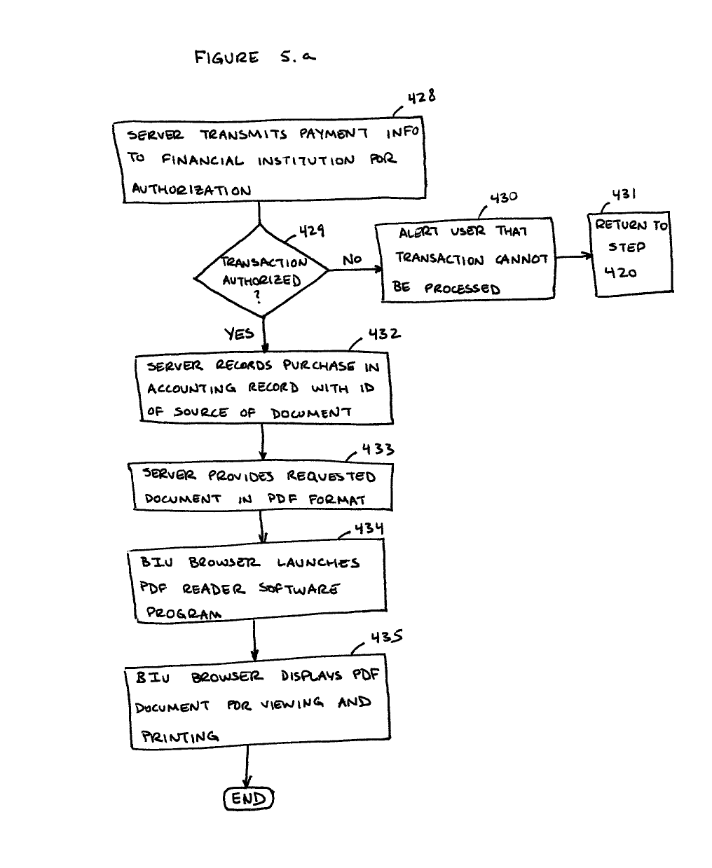

FIGS. 5 and Sa depict the process undertaken when at step 407, a business information user is provided a web page listing forms and documents available for download on a fee basis. At step 420, server 100 provides a web page listing documents that are available from storage device 102 for download on a fee basis, and at step 421, the business information user's browser displays the requested web page. At step 422 a user selects a single document from the list of documents in which they have an interest, and responsive to that selection, server 100 at step 423 provides a web page providing outline information relating to the business form, including information relating to how the form can be used. After the business information user has reviewed the outline information, at step 424 the user is prompted to state his or intent to purchase the document. If the user elects not to purchase the document currently described, the user is directed back to step 420. Alternately, if the user does elect to purchase the document, server 100 again provides the same download conditions at step 425 as with freely downloadable forms, and at step 426 requires the user's agreement before proceeding. If the user does not agree to the terms, they are again directed back to step 420. However, if the user does agree, the server at step 427 provides a web page requiring the user to input sufficient financial information to support a purchase transaction of the document of interest. For example, the web page presented to the user at step 427 may require input of the user's mailing address, billing address, and credit card information. After such information has been input by the user, at step 428 the server transmits such information to a financial institution (800 of FIG. 1). At step 429, server 100 performs an analysis to determine whether or not the financial institution has approved the transaction and, if not, at step 430 alerts the user that the transaction cannot be processed, and at step 431 returns the user to step 420. Alternately, if the purchase transaction is approved, at step 432 the server records the purchase in an accounting record with an identification of the particular customized form provider 300 that authored the purchased document for future reconciliation. At step 433, the server then provides the requested document in PDF format, and at step 434 the business information user's browser launches a PDF Reader software program so that at step 435, the user's browser may display the document for viewing and printing.

In an alternate embodiment of the instant invention, prior to steps 410 and 420, the server may optionally allow the business information user to select a particular geographic region or state of interest to the user. Once the user has selected the particular geographic region or state, the user is presented a listing of the appropriate collection of forms, whether customized or non-customized, that are particularly configured for the geographic region or state that was selected by the user.

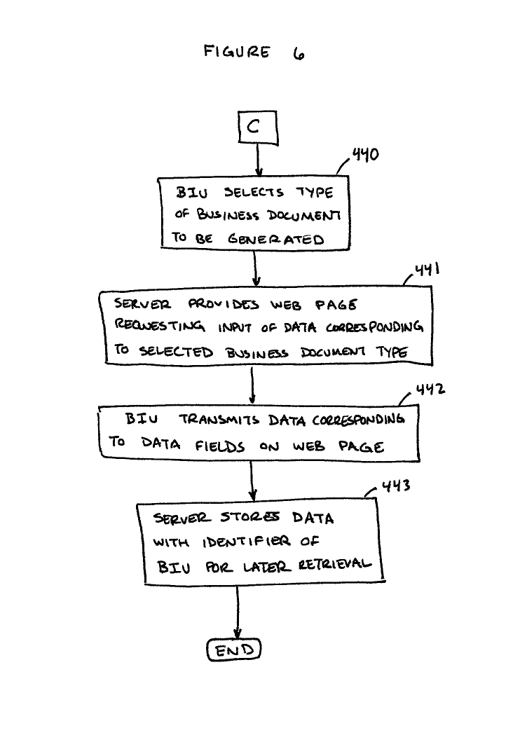

FIG. 6 depicts the process undertaking when at step 408, a business information user is provided a web page enabling user input of business information that is to be used to create a business document. The web page provides an area where the business information user may submit an electronic version of their document(s) and software, if any, including web site graphical user interfaces and CD-ROM based software, which may in turn be retrieved by document processing personnel using a file transfer protocol (FTP) directly into local development software used by the processing personnel, who use such submitted materials to create a multimedia product on CD-ROM, DVD, or other electronic storage medium. As shown in FIG. 6, at step 440 the business information user first selects the type of business document to be generated from a plurality of types provided on the web page. For example, the web page may provide selections for “Create Business Plan,” “Create Shareholder Report,” “Create Press Release,” and the like. In response to such selection, at step 441 server 100 provides a web page requesting input of data corresponding to the particular business document type that was selected by the user at step 440. Thus, each document type may have a distinct “data entry” web page soliciting data that is particularly well adapted for such business document type. At step 442, the business information user then transmits data corresponding to the particular data fields presented on the web page, in addition to billing and other identifying information relating to the particular business information user. At step 443, server 100 then stores the user's data and indexes such data so that it may be linked to the particular business information user to aid the development personnel in future retrieval of such data.

It is of note that virtually all business documents today are created using word processing software which may be rendered into files suitable for integration into and for the creation of a multimedia product and then merged with color graphics, software demonstrations, web site demonstrations, and other robust presentations which are supported only by a multimedia CD-ROM, DVD, or other electronic storage medium. Thus, the method and system of the instant invention may create multimedia CD-ROM/DVD business plans, annual shareholder reports, private placement memorandums, and the like by accepting uploaded information to the system of the instant invention, which is then used to create a multimedia version of the document. Such document, when complete, may thus include video, graphics, text, and software if those assets were provided in the uploaded information.

The advantages of putting documents such as an annual shareholder report, business plan, or private placement memorandum onto CD-ROM, DVD, or similarly configured electronic storage medium are numerous, including enabling a relatively low-cost, compact distribution medium which allows for quick and accurate selective access into its multimedia contents. Text, videos, and graphics can be incorporated into the medium allowing the user easy access to new media presentations of any business model. This may also include demonstrations of the business's Web site, its CD or DVD product(s), text, graphs, Power Point presentations, video presentations by company personnel (e.g., a CEO presentation to shareholders), music, and the ability to hyper-link to a company's web site. Additionally, the disc may enable printing of selective text, graphs, and all the necessary forms for review and/or execution pursuant to making an investment in the company.

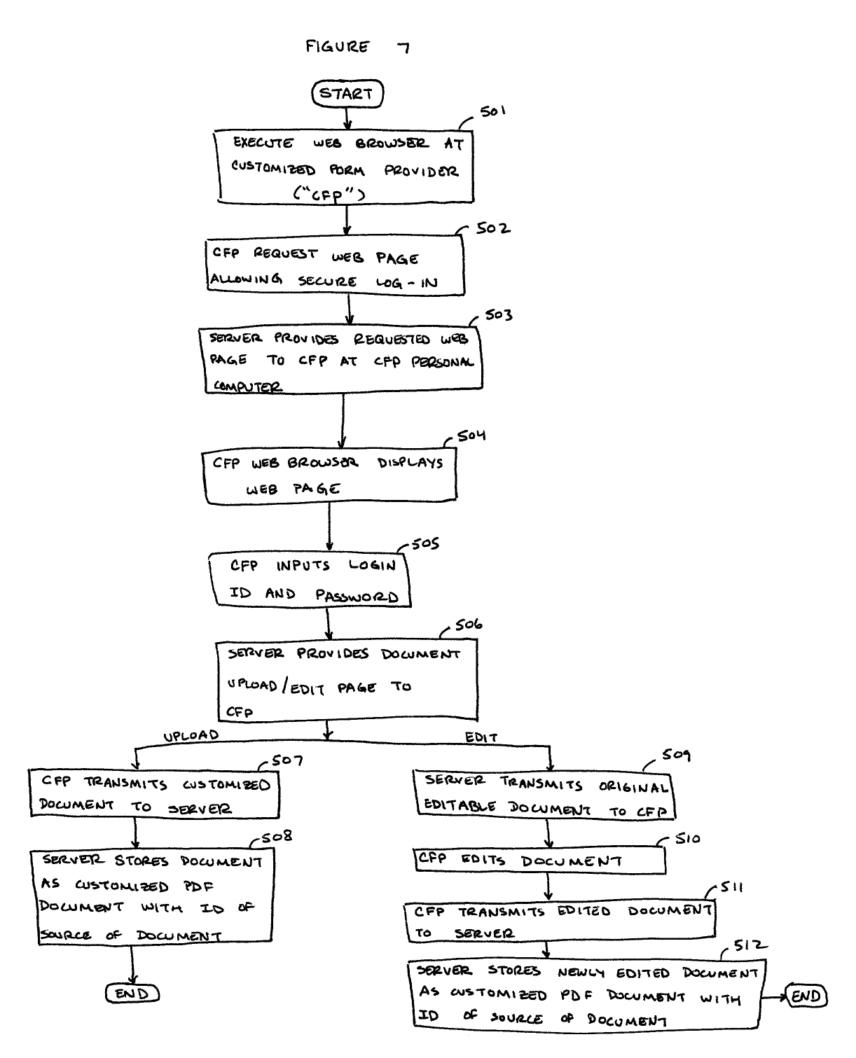

FIG. 7 is a schematic representation of the process undertaken by a customized document provider 300 in either uploading a new customized document to server 100, or editing a customized document previously submitted to server 100. At step 501, a personal computer at the location of the customized document provider 300 executes a web browser program and connects to communication link 310 enabling communication with remote hosts, such as remote server 100. Next, at step 502, the customized form provider requests a web page from remote server 100 allowing secured login to access that provider's personal information record stored on server 100 and any previously uploaded customized documents. At step 503, server 100 provides the requested web page to the web browser on the provider's computer 300, and at step 504, the browser program displays the web page. At step 505, the provider then inputs a unique login ID and password which identifies the provider to server 100, and allows the user access to that user's files stored on server 100.

After the provider has successfully logged onto server 100, the server provides at step 506 a document upload/edit page to the provider's browser, and prompts the provider to either upload a new document or edit a previously uploaded document. If the customized form provider elects to upload a new document, at step 507 the provider transmits a new customized document to server 100, and at step 508 server 100 publishes the document as a PDF file and stores the document on storage device 102 as a customized PDF file, along with an identification of the source of the document. Alternately, if the provider elects to edit a previously uploaded document, at step 509 server 100 transmits the original, editable document to the provider who, at step 510 makes the desired revisions, and at step 511 transmits the edited document back to server 100. At step 512, server 100 then stores the newly edited document as a customized PDF file, preferably overwriting the previous version of such file, along with an identification of the source of the document. Both newly uploaded and edited documents are then available for further download by business information users 200.

In order to associate each customized form with a particular customized form provider, any time a new or edited form is received by server 100 from a provider 300, server 100 assigns a supplier identification code associating that form with the particular provider, such that payment may be remitted to that provider for each form that is sold. Optionally, each new form uploaded to server 100 may be routed to a review database where such file will remain until retrieved, reviewed, and approved by a human observer for distribution to users. Once approved, the human observer transfers the uploaded document to document database 110.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention may be practiced otherwise than as specifically set forth herein.

I claim:

1. A system for automating a business's management of business information comprising:
a server computer hosting a business information exchange service accessible via client computers to a plurality of business information users and a plurality of customized form providers, said business information exchange service further comprising
a first user interface comprising controls whereby a business information user selects, receives, and transmits business information; and
a second user interface comprising controls whereby a customized form provider transmits and edits business information; and
a database of business information;
whereby said business information exchange service is available via a computer network to assist business information users in obtaining customized and noncustomized business documents.

2. The system of claim 1, said database of business information further comprising business information transmitted by said second user.

3. The system of claim 1, said first user interface further comprising:
a first control for providing a web page to said first user listing business information available for transmission to said first user without cost;
a second control for providing a web page to said first user listing customized business information available for transmission to said first user for a fee; and
a third control for providing a web page to said first user enabling said first user to transfer business information to said server for producing a business document therefrom.

4. A method for providing customized and noncustomized business information to remote users, comprising the steps of:
a) providing a web site having a first user interface comprising controls whereby a business information user selects, receives, and transmits business information, and a second user interface comprising controls whereby a customized form provider transmits and edits business information;
b) receiving at said web site a first business information user input indicative of a desired category of available document transfer services; and
c) transmitting to said business information user a desired web page enabling the transfer of business information between said web site and said business information user.

5. The method of claim 4, wherein said web page transmitted to said business information user lists noncustomized business information available for transmission to said first user without cost.

6. The method of claim 5, further comprising the step of:
d) receiving at said web site a first business information user input indicative of a desired noncustomized business information document to download from said web site without cost.

7. The method of claim 6, further comprising the steps of:
e) transmitting to said business information user a web page listing document download conditions;
f) receiving at said web site business information user input indicative of said business information user's agreement to said conditions; and
g) transmitting to said business information user said desired noncustomized business information document in read only form.

8. The method of claim 4, wherein said web page transmitted to said business information user lists customized business information available for transmission to said first user for a fee.

9. The method of claim 8, further comprising the step of:
d) receiving at said web site a first business information user input indicative of a desired customized business information document to download from said web site for a fee.

10. The method of claim 9, further comprising the steps of:
e) transmitting to said business information user a web page providing an outline description of said desired customized business information document;
f) receiving at said web site business information user input indicative of said business information user's intention to purchase said document;
g) transmitting to said business information user a web page listing document download conditions;
h) receiving at said web site business information user input indicative of said business information user's agreement to said conditions; and
i) transmitting to said business information user said desired customized business information document in read only form.

11. The method of claim 4, wherein said web page transmitted to said business information user lists customized business information available for generation at said web site.

12. The method of claim 11, further comprising the step of:
d) receiving at said web site a first business information user input indicative of a desired class of customized business information document to be generated at said web site.

13. The method of claim 12, further comprising the steps of:
e) transmitting to said business information user a web page requesting input of data corresponding to the selected class of customized business information document to be generated;
f) receiving at said web site business information user input data corresponding to said selected class; and
g) storing said data with an identification of said business information user for later retrieval.

14. A method for providing customized and noncustomized business information to remote users, comprising the steps of:
a) providing a web site having a first user interface comprising controls whereby a business information user selects, receives, and transmits business information, and a second user interface comprising controls whereby a customized form provider transmits and edits business information;
b) receiving at said web site a first customized form provider input indicative of a login identification specific to said customized form provider; and
c) transmitting to said customized form provider a web page listing a plurality of customized business information handling functions accessible by said customized form provider.

15. The method of claim 14, wherein said customized business information handling functions comprise uploading new customized business information and editing previously stored customized business information.

16. The method of claim 15, further comprising the steps of:
d) receiving at said web site customized business information from said customized form provider; and
e) storing said customized business information as a customized read only document with an identification of said customized form provider.

17. The method of claim 15, further comprising the steps of:
d) transmitting to said customized form provider a previously stored customized business information document associated with said customized form provider;
e) receiving from said customized form provider an edited version of said previously stored customized business information document; and
f) storing said edited version of said customized business information as a customized read only document with an identification of said customized form provider.
